(19) United States
(12) Patent Application Publication
(10) Pub. No.: US 2009/0003217 A1
(43) Pub. Date: Jan. 1, 2009

(54) Network Optimisation System

(76) Inventors: Herman Lucas Ferra, Victoria (AU); Robert Palmer, Victoria (AU); Michael John Dale, Victoria (AU); Peter Kenneth Campbell, Victoria (AU); Karl Alan Christiansen, Victoria (AU); Adam Kowalczyk, Victoria (AU); Jacek Szymanski, Victoria (AU)

Correspondence Address: Dorsey & Whitney LLP;US Bank Center, 1420 Fifth Avenue, Suite 3400, Seattle, WA, 98101-4010, US

(21) Appl. No.: 11/571,092

(22) PCT Filed: Jun. 23, 2005
(86) PCT No.: PCT/AU05/00909

§ 371 Date: Feb. 22, 2008

(30) Foreign Application Priority Data
Jun. 23, 2004 (AU) 2004903439

(51) Int. Cl. G01R 31/08

(52) U.S. Cl. 370/238

(57) ABSTRACT

A network optimisation system including a neural network module (200) for receiving traffic data representing traffic for a communications network and generating path configuration data representing paths between origin and destination nodes of the network for the traffic, and an analysis module (210) for processing the path configuration data and the traffic data and generating optimal path configuration data for the traffic. The analysis module may use a marginal increase heuristic (MIH) process, and a neural network may be trained on the basis of path configuration data generated from traffic data processed using a mixed integer linear programming (MILP) process.

### FIELD

The present invention relates to a network optimisation system, and a network optimisation process.

### BACKGROUND

Network management systems are used to seek optimal use of resources in communications networks, particularly large scale public telecommunications networks. For any given network topology, the links between the various nodes of a network have a limited capacity to meet network traffic demands or requests, and the network should be managed so as to satisfy the demand as efficiently as possible. Network management systems are available to manage and configure different networks on demand, and multi-protocol label switching (MPLS) networks provide considerable flexibility to network operators to undertake traffic engineering on demand. In particular, MPLS networks allow traffic flows to be directed onto selected paths between originating and destination nodes as selected by the network operator. One particular problem that needs to be solved for network optimisation is to determine the best way in which to distribute the traffic flows over the available network elements in order to improve network performance. In particular, the optimum paths through the network should be selected for the traffic demand at any given point in time. Being able to explicitly select a path allows an operator to effectively employ under-utilised links, when determined, in order to carry extra traffic, and to avoid parts of the network which are congested, again if these parts can be determined. If this can be achieved, packet delay and loss experienced by traffic flows can be minimised, and a consequent increase in effective traffic carrying capacity of the network delivered. Network optimisation will also be more effective if the path selection process allows the network to be reconfigured in real-time so as to react to load conditions in a short time frame to minimise congestion and loss.

A number of processes have been developed to perform network optimisation. One process involves determining optimal paths by formulating the problem in a form that is solved using a linear programme (“LP”) process with integer constraints, known as Mixed Integer Linear Programming (MILP), as discussed in Fabrice Poppe, Sven Van den Bosch, Paloma de La Vallée-Poussin, Hugo Van Hove, Hans De Neve and Guido Petit, Choosing the Objectives for Traffic Engineering in IP Backbone Networks based on Quality-of-Service Requirements, Proceedings of the First International Workshop on Quality of Future Internet Services (QoFIS), Berlin, Germany, Sep. 25-27, 2000, (“Poppe”); Alpár Jüttner, Balázs Szviatovszki, Áron Szentesi, Dániel Orincsay, János Harmatos, On-demand optimization of label switched paths in MPLS networks, Proceedings Ninth International Conference on Computer Communications and Networks, 16-18 Oct. 2000, Las Vegas, Nev., USA, (“Jüttner”); and M. Herzberg and S. J. Bye, Bandwidth Management in Reconfigurable Networks, Australian Telecommunications Research, Vol. 27, No. 2, 1993, (“Herzberg”). Most often the integer constraints are used to represent practical requirements of the network architecture, protocols or management systems. For example, bandwidth might be allocated in quanta, as in Herzberg, or it may be desirable for flows to be restricted to a single path through the network, as in Poppe, or paths which carry flows must be disjoint, as in Jüttner. MILP processes are performed in two-stages which when successful guarantee that the solution is a global optimum selection of paths relative to a chosen objective. The two-stages consist of an LP-relaxation phase in which the integer constraints are ignored and the pure linear programme is executed. This is then followed by a subsequent search for a solution near the pure LP optimum, which further satisfies the integer constraints. It is this second stage that often leads to problems in implementing an MILP process for path selection. For instance, whilst the LP-relaxation phase may have a feasible solution there may not exist a corresponding solution for the complete MILP process. In fact even if such a solution exists there is no guarantee that it can be found within an acceptable time frame for use by a network optimisation system.

The above deficiencies have lead system developers to employ the use of heuristic processes as discussed in, F. A. Kuipers, T. Korkmaz, M. Krunz and P. Van Mieghem, Overview of Constraint-Based Path Selection Algorithms for QoS Routing, IEEE Communications Magazine, Vol. 40, No. 12, December 2002, (“Kuipers”); Yufei Wang and Zheng Wang, Explicit Routing Algorithms for Internet Traffic Engineering, Proc. of IEEE ICCCN'99, Boston, October, 1999, (“Wang”); and G. Gopal, C. Kim, and A. Weinrib, Algorithms for Reconfigurable Networks, Proceedings of 13th International Teletraffic Congress, Copenhagen, Denmark, June 1991, pp. 341-347, (“Gopal”). These processes may provide sub-optimal results, but are generally much faster than solving the problem formulated for the MILP process directly. Often though, the solution provided by a heuristic process is not uniformly good over the entire solution space, and the performance can be affected by the initial conditions assigned to the process.

Accordingly, it is desired to address the above or provide at least a useful alternative.

### SUMMARY

The present invention provides a network optimisation system, including:
a neural network module for receiving traffic data representing traffic for a communications network and generating path configuration data representing paths between origin and destination nodes of said network for said traffic; and
an analysis module for processing said path configuration data and said traffic data and generating optimal path configuration data for said traffic.

The present invention also provides a network optimisation process, including:
receiving traffic data representing traffic for a communications network;
processing said traffic data using a neural network to generate path configuration data representing paths between origin and destination nodes of said network for said traffic; and
processing said path configuration data and said traffic data to generate optimal path configuration data for said traffic.

### BRIEF DESCRIPTION OF THE DRAWINGS

Preferred embodiments of the present invention are hereinafter described, by way of example only, with reference to the accompanying drawings, wherein:

FIG. 1 is a block diagram of an example embodiment of a network optimisation system;

FIG. 2 is a block diagram of a network optimiser of the system;

FIG. 3 is a block diagram of a training data generation system of the network optimisation system;

FIG. 4 is a block diagram of a training system to generate the neural network used by the network optimisation system.

FIGS. 5 to 7 are data flow diagrams of a solution refinement process of the system;

FIG. 8 is a flow diagram of a balance and usage determination process of the system;

FIG. 9 is a flow diagram of a feasible path determination process of the system;

FIG. 10 is a flow diagram of the OD pair capacity determination process of the system;

FIG. 11 is a flow diagram of a link cost determination process of the system;

FIG. 12 is a flow diagram of a path cost determination process of the system; and

FIG. 13 is a benefit value determination process of the system.

### DETAILED DESCRIPTION OF THE PREFERRED EMBODIMENTS

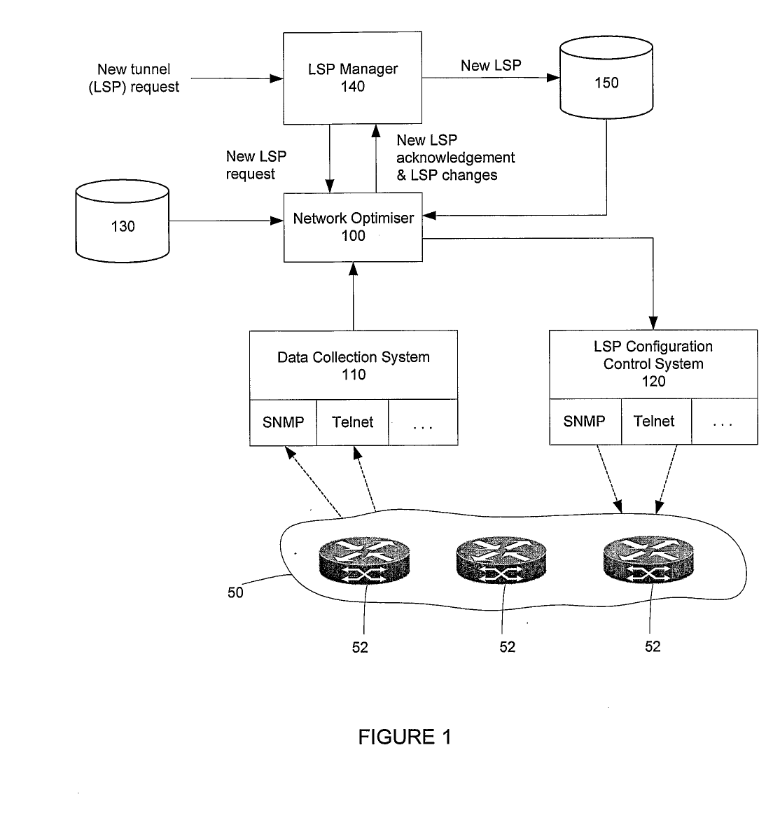

A network optimisation system, as shown in FIGS. 1 to 4, includes a traffic data collection system 110, a network optimiser 100, a path manager 140, a path configuration control system 120, a training data generation system 300 and a neural network training system 450.

The data collection system 110 receives traffic data, via communications protocols, such as SNMP, FTP and Telnet, from switches and routers 52 of the network 50. The traffic data supplied by the network elements 52 represents the current measured traffic demand for each origin-destination (OD) pair of nodes 52 in the network 50. Data representing the topology of the network 50 is held in a network topology database 130 for the network optimiser 100 and training data generator system 300. The network topology data includes data on the maximum capacity for each link and the nodes 52 to which each link connects. Each link is assigned an identification (ID) number and the capacities are provided in Mbps or other suitable units.

The network optimiser 100, as described in detail below, generates optimal path configuration data that represents the optimal traffic paths to be utilised between origin and destination points or nodes 52 of the network 50. For any given OD pair of nodes 52, one or more paths through the network may be utilised and defined by the path configuration data. The defined paths each include one or more links between an OD pair and a defined capacity. The paths are each labelled in a manner which enables the path configuration control system 120 to reserve the required capacity on each link of the path and establish the intended sequence of nodes 52 and links that will enable the origin to transmit traffic to the destination at the desired rate.

Hereinafter, the paths are described as being label switched paths (LSPs) of a multi-protocol label switching (MPLS) network which utilises the MPLS protocol, and in particular the MPLS shim header, to send packets along the paths. The nodes 52 may therefore be a label edge router (LER) or a label switch router (LSR). A LER converts Internet protocol (IP) packets into MPLS packets and MPLS packets into IP packets, and are able to determine whether a packet should be labelled based on data held in the LER that matches the destination address to a label of at least one LSP. LSRs analyse packets to determine the outgoing link based on the LSP label data that it holds, and generally perform a label swapping function. The MPLS shim header of MPLS packets is pushed between OSI layers 2 and 3 of IP packets and includes the label data. It will be appreciated by those skilled in the art that the network optimisation system can be applied to operate with any communications network which allows network paths to be defined and then controlled in a similar manner to LSPs, such as the virtual paths of ATM networks.

The network optimiser 100 can work in a variety of ways depending upon the type of traffic being carried by the network 50. If only guaranteed bandwidth traffic is being carried by the network 50, requests for new LSPs, or existing LSPs with a modified bandwidth requirement, arrive at a label switched path (LSP) Manager 140 which passes the request to the network optimiser 100. The network optimiser 100 determines optimal path configuration data for the new LSP request and any already established LSPs carrying guaranteed bandwidth traffic, if these are required to change in order to accommodate the new request.

When a guaranteed bandwidth LSP is no longer required the LSP Manager 140 is notified and the network optimiser 100 is informed of the change. This can lead to a re-optimisation of the remaining LSPs if a more favourable configuration of paths can be found.

For “best effort” traffic there is no minimum bandwidth requirement. If best effort traffic is being carried by the network then the network optimiser 100 collects traffic data from the data collection system 110 which measures the current offered traffic for each OD pair in the network. The network optimiser 100 determines optimal path configuration data based on this measurement or snapshot of the current activity of the OD Pairs.

If a combination of guaranteed bandwidth LSPs and best effort LSPs are required, the network optimiser 100 can determine optimal path configuration data such that the minimum capacity requirement of the guaranteed bandwidth traffic is met first, with any left over capacity in the network 50 used to service the best effort LSPs.

The network optimiser 100 determines the path configuration data for the optimal LSPs based on:
(i) The current allocated LSPs. Data representing the existing LSP assignments, together with a capacity allocated for each path, is held in a database 150 of the optimisation system.
(ii) The network topology data provided by the database 130.
(iii) Traffic data. The traffic data represents the current traffic demand as provided by the data collection system 110, and any traffic demand associated with a new and existing guaranteed bandwidth LSP requests.

Any new guaranteed bandwidth LSP request is received and passed to the network optimiser 100 by a label switched path (LSP) manager 140. The LSP manager 140 receives a request for new guaranteed bandwidth LSPs to be established in the network 50 from network operators, other network systems or customers. The origin and termination (destination) points of LSPs can be access routers and core routers (to which a group of access routers are connected) within the network operator's network, or routers located on a customer's premises. The LSP request normally specifies a request for an origin destination (OD) path, and in particular, a request for an OD path to carry guaranteed quality of service (QoS) traffic, includes the capacity required of the path. For best effort traffic, the data collection system 110 provides a current measurement of the OD pair traffic demands which could represent an increase or decrease on the previous measurement. These requests for new, or existing LSPs with a modified bandwidth requirement (either guaranteed bandwidth or best effort), are passed to the network optimiser 100. If the network 50, as determined by the network optimiser 100, can satisfy the requirements of the guaranteed bandwidth requests, the LSP manager 140 is advised. Any existing LSPs that have to change due to the new request or varying traffic conditions are also passed on to the LSP manager 140 which updates the database 150 to contain all the LSPs, whether best effort or guaranteed bandwidth, that are currently in use. If the requested parameters of the LSP cannot be met, the LSP manager 140 is advised and has the option of returning a rejection of the LSP request, or modifying the request requirements to a level that the network can satisfy. The database 150 is used to store the complete set of network paths in use by the network at any given time. This information can be used by other network management or customer management systems (eg billing).

The LSP configuration control system 120 receives the LSP configuration data produced by the network optimiser 100, and generates control messages for the network nodes 52 in order to realise the required network configuration specified by the configuration data. The control messages use management protocols, such as SNMP or commands specific to the particular network equipment 52 and communicated using protocols, such as Telnet or FTP.

In order to simplify the description, it is assumed hereinafter that the network only carries best-effort traffic. The handling of only guaranteed bandwidth traffic is virtually identical, the only difference being whether the traffic demand data comes to the network optimiser 100 from the LSP manager 140 or the data collection system 110. The hybrid situation of both types of traffic can be accommodated in a variety of ways. One way is through the introduction of virtual OD pairs. For each real OD pair in the network 50 a virtual OD pair is introduced with access to all the same network paths as the corresponding real OD pair. All the guaranteed bandwidth traffic is associated with the real OD pairs and any best effort traffic with the virtual OD pairs. In such a case the network optimiser is configured to give preferential treatment to the capacity allocations needed by the real OD pairs.

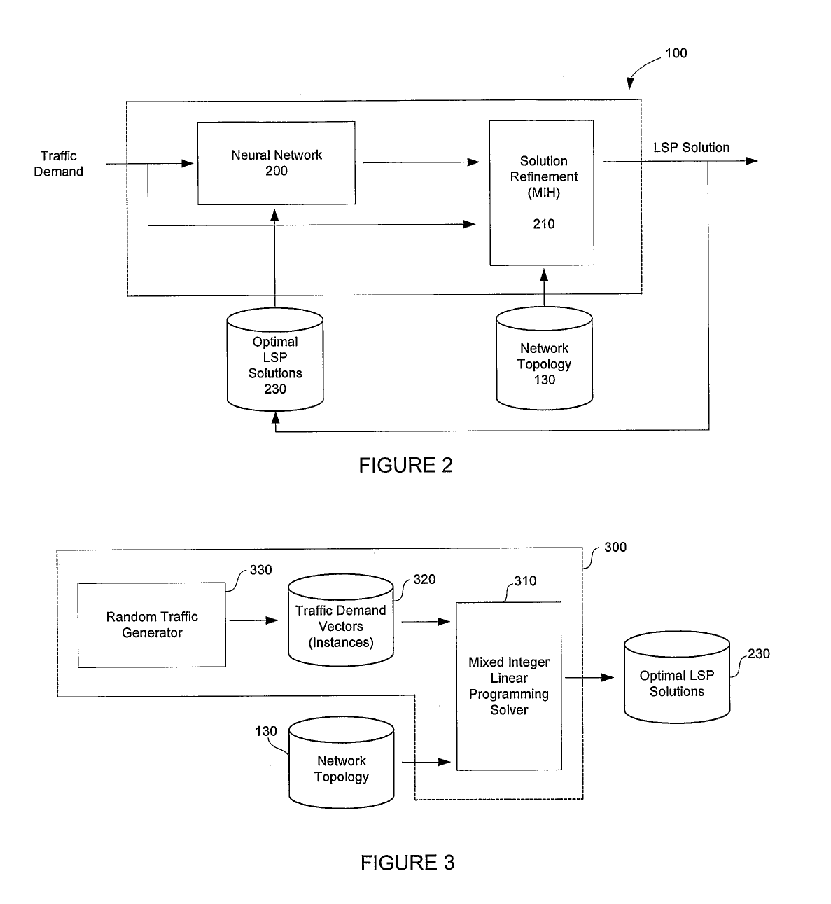

The network optimiser 100, as shown in FIG. 2, includes a neural network 200, and a solution refinement analysis system 210. The neural network 200 is trained on the basis of path configuration data representing optimal solutions stored in and provided by an optimal LSP solution database 230. The neural network 200 is initially trained using this path configuration data which is generated by the training data generation system 300. Once trained, as described below, the neural network 200 produces path configuration data representing an optimal or near optimal LSP solution based on the traffic data it receives. The traffic data for all the origin-destination pairs in the network 50 is received as a traffic demand vector for the n(n−1) OD pairs for a network 50 having n termination nodes. The vector includes values of capacity Cᵢ for each OD pair i. The path configuration data solution output represents a set of LSPs for each OD pair, and a capacity value for each LSP. The solution allocates one or more LSPs to an OD pair. The LSP solution data produced by the neural network 200 is passed to the refinement analysis system 210 together with the traffic data for further analysis and refinement. The example refinement analysis system 210 described below uses a marginal increase heuristic process (MIH), but other alternatives are also available, such as reinforcement learning for instance. The refinement system 210 produces the output of the optimiser 100 using the network topology data contained in the database 130. The LSP solution produced by the network optimiser 100 is used to configure the network. The neural network 200 is able to quickly produce a near optimal solution which provides the refinement system 210 with less processing to execute in order to produce an optimal LSP solution, thereby enabling the optimiser 100 to obtain the optimal network configuration in a very short period of time. If the capacity requirements for all OD pairs are satisfied by the solution produced by the neural network 200, and there is no violation of any other constraints then the optimal solution output by the optimiser 100 will be the solution produced by the neural network 200.

The neural network 200 is initially trained using data generated by the training data generation system 300 which produces an optimal LSP solution set 230 for the network 50. The training data generation system 300 is based on a mixed integer linear programming (MILP) solver system 310 which generates the initial solution set for the database 230 based on the network topology data 130 and a set of example traffic demand vector instances stored in a database 320. The example traffic demand vectors may be generated by a random traffic demand vector generator 330 or may consist of historical data collected from the network itself. The random traffic generator 330 produces a set of traffic demand vectors (being demand values for OD pairs of the network) that represent the expected traffic conditions for the OD pairs of the network 50. The generator 330 is controlled by a probability distribution function. The traffic demand vectors 320 and the network topology data from the database 130 are fed to the MILP system 310. The MILP system 310 includes MILP software to generate an optimal LSP solution for each demand vector. MILP software packages that may be used, include the CPLEX package from ILOG Inc. (http://www.ilog.com), XPRESS-MP from Dash Optimization Ltd (http://www.dashoptimization.com) and GLPK, the GNU linear programming kit. Herzberg also describes a particular MILP process for optimising network paths in the telephony environment. Most, if not all of, the constraints of the process derive from the constraints of the network, eg. traffic allocated to a link cannot exceed its maximum capacity.

On occasion the neural network 200 may require re-training, for instance if the network topology changes significantly due to network growth, or the average traffic demand levels increase. In such a case the training data generation system 300 is employed again to generate a new training data set. Any network topology changes are fed in to network topology database 130 and the traffic data generator 330 is updated to reflect any changes in the expected traffic demands prior to generating the new data set.

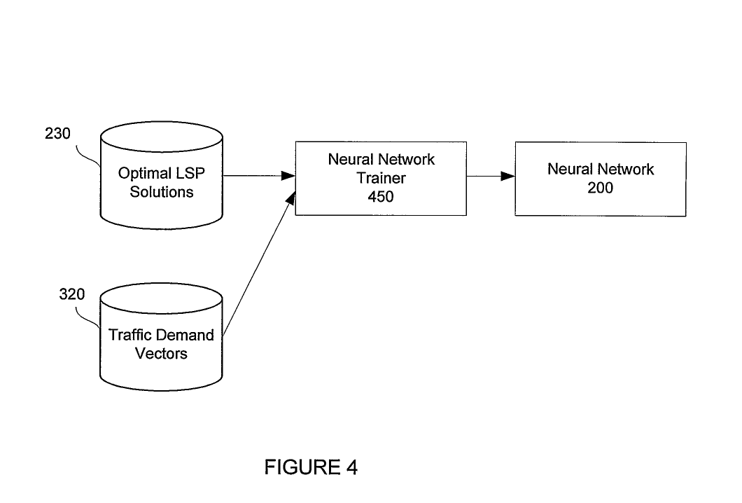

The training set produced by the training data generating system 300 comprises the optimal LSP solution 230 and the traffic demand vectors stored in the database 320. The vectors each contain one entry for each OD pair in the network 50. Each value in a vector corresponds to the traffic demand for that OD pair, and each vector represents a snapshot in time of the traffic demands for each OD pair. For each traffic demand vector in the database 320 the corresponding labelled LSP routes, as determined by the MILP system 310 are stored in the database 230. The neural network 200 is then trained to learn the relationship between the traffic demand vectors and the optimal network paths. The training process is performed by a neural network trainer 450, as shown in FIG. 4. The physical node connectivity and link capacity can change when the network 50 is upgraded, requiring retraining of the neural network 200 to take these changes into account. The amount of data required to train the neural network is influenced by a number of factors, such as the size and complexity of the topology as well as the traffic types being carried. It has been demonstrated on some non-trivial example networks that as little as two hundred instances may be sufficient. When the training requirements are this modest, this makes the MILP system 310 particularly efficient.

A number of different neural networks can be employed, together with their respective training processes. An example of a neural network and training process that can be employed is described in A. Kowalczyk and H. L. Ferrá. Developing higher order networks with empirically selected units, IEEE Trans. Neural Networks, pp 698-711, 1994. SAS Enterprise Miner by SAS Institute Inc. (http://www.sas.com), IBM Intelligent Miner by IBM Corporation (http://www.ibm.com), or SPSS Clementine by SPSS Inc. (http://www.spss.com) may be used in the implementation. A significant advantage of generating a neural network 200 from the solution set produced by a MILP solver 310 is that the neural network 200 is able to handle non-obvious relationships between the input traffic demand vectors and the output LSP solution set that may not be able to be produced using heuristic processes.

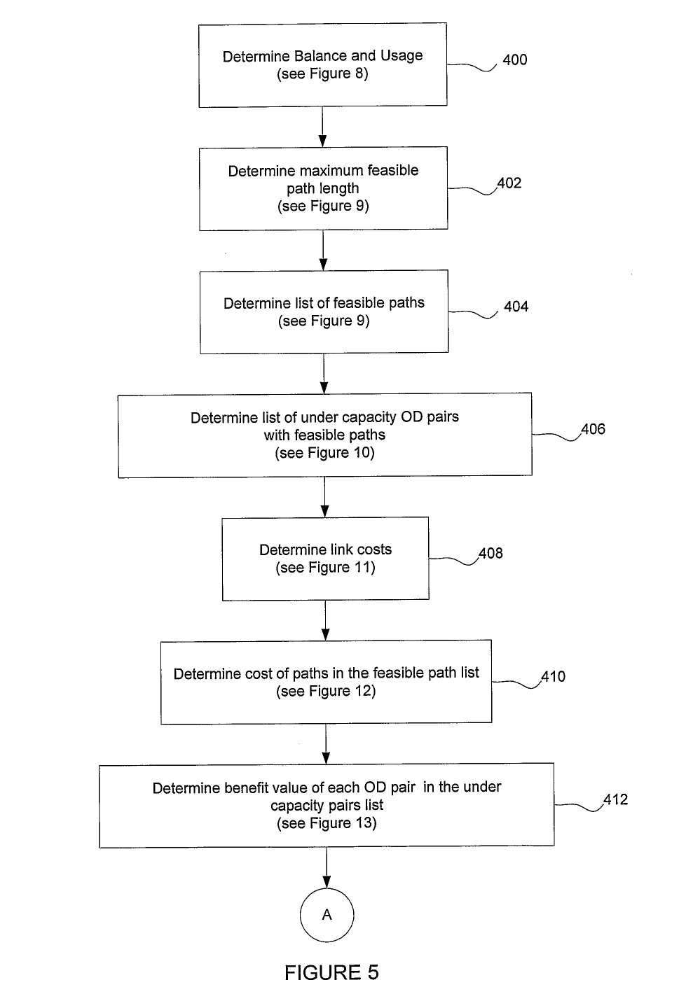

The MIH process executed by the solution refinement system 210, as shown in FIGS. 5 to 13 is based on principles described in Gopal, and operates to allocate capacity to traffic between OD pairs, one unit at a time, until either all OD pairs have their capacity requirements satisfied, or there is no path capable of transporting the extra unit of capacity. The MIH process used in the solution refinement system is dependent on the optimisation objective determined by the network operator. Some possible objectives include maximisation of throughput, minimisation of packet loss and maximisation of resource availability, ie spare capacity. The objective function used in the MIH described below with reference to FIGS. 5 to 13 is to maximise M×B−U, where B is the network balance, defined as the smallest fraction of spare capacity left on any link in the network, and U is the network usage which is defined as the total capacity used in the network. The value M is a large positive constant which can be used to adjust the relative importance of the two terms B and U in the optimisation process. By maximising the value of B, the traffic is spread out as evenly as possible across the network, thereby reducing the potential of generating localised congestion, which can occur when any link in the network carries a high fraction of its maximum capacity, and other links may have spare capacity. Maximising the value of B is expected to reduce the packet loss and delay experienced by the OD pairs.

The system 210 operates on the LSP solution list produced by the neural network 200, which is automatically adopted by the refinement system 210 if no OD pairs of the solution produced by the neural network 200 are under capacity. Otherwise, the MIH process iteratively operates through the LSP solution list to produce an optimal LSP solution.

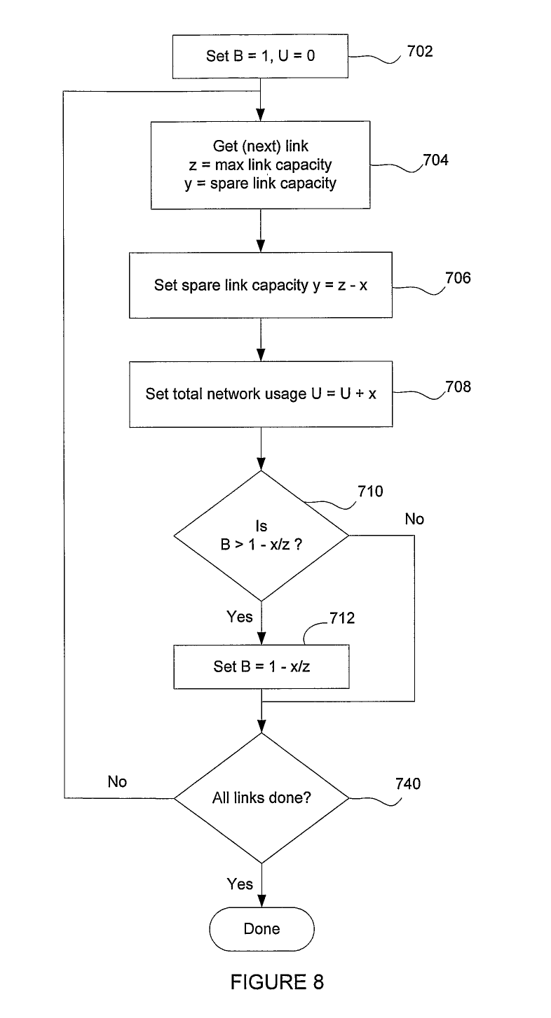

The MIH process commences at step 400 in order to determine the balance (B) and usage (U) for the network 50. Initially the balance variable B is assigned a value 1 and the usage variable U is assigned a value 0 at step 702, as shown in FIG. 8. At step 704, the next link in the network is retrieved. All links of the network are examined and not just the links referred to in the LSP solution list generated by the neural network, as the list may be only a subset of the network links. The maximum capacity of the retrieved link is assigned to a variable z. The LSP solution list is examined to determine the amount of allocated capacity for that link. If the link is unused in the LSP solution list, the allocated capacity for the link is zero. The allocated capacity for the link is assigned to a variable x and the spare capacity of the link is assigned to a variable y. The maximum capacity comes from the topology database 130. The spare capacity is determined by looking at the solution proposed by the neural network and subtracting the capacity allocated to all the paths traversing that link (ie the variable x) from the maximum capacity of the link. Any links not used in the solution proposed by the neural network have spare capacity y equal to z. The spare capacity of the link is determined as being the difference between z and x step 706.

At the termination of the loop in FIG. 8, the total network usage U and the balance B will have been computed for the current allocation of capacity to LSPs. At each iteration, in step 708 the value of U is increased by the value of the used capacity (x) on the link. In step 710 the current value of B is checked against the fractional spare capacity of the link (y/z=1−x/z) and B is assigned this value if the fraction of spare capacity for this link is less than the current value of B at step 712. Thus at the termination of the loop B will be the smallest value of the fractional spare capacity of any link in the network. At step 740, a determination is made as to whether all links have been analysed, and if not then steps 704 to 740 are executed again for the next link in the solution set.

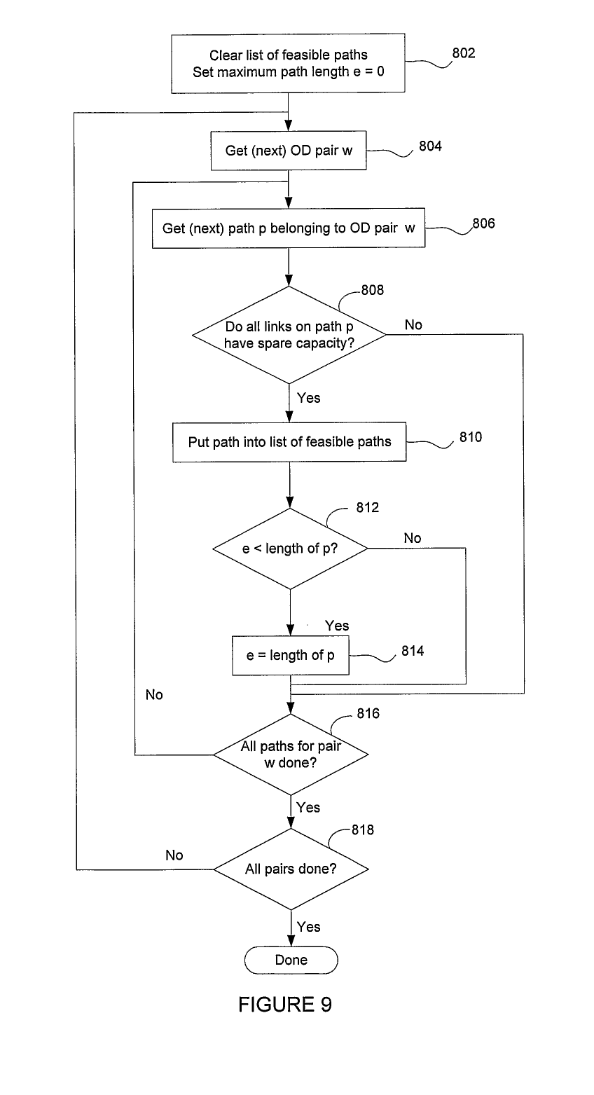

Operation subsequently proceeds to step 402, in which the maximum feasible path length of the network 50 is determined and a list of feasible paths for each OD pair determined. At step 802, as shown in FIG. 9, a list of feasible paths is cleared and the maximum feasible path length variable e is set to 0. At step 804, the next OD pair w in the solution list is accessed. At step 806, the next path p belonging to OD pair w is accessed. At step 808, a determination is made as to whether all links on path p have spare capacity. If not, operation proceeds to step 816, otherwise path p is put into a list of feasible paths, at step 810. If maximum feasible path length e is less than the length of path p (812), then e is set to be the length of p (814). At step 816, a determination is made as to whether all paths of OD pair w have been processed, and if not operation returns to step 806. At step 818, a determination is made as to whether all of the OD pairs in the solution list have been processed, and if not operation returns to step 804.

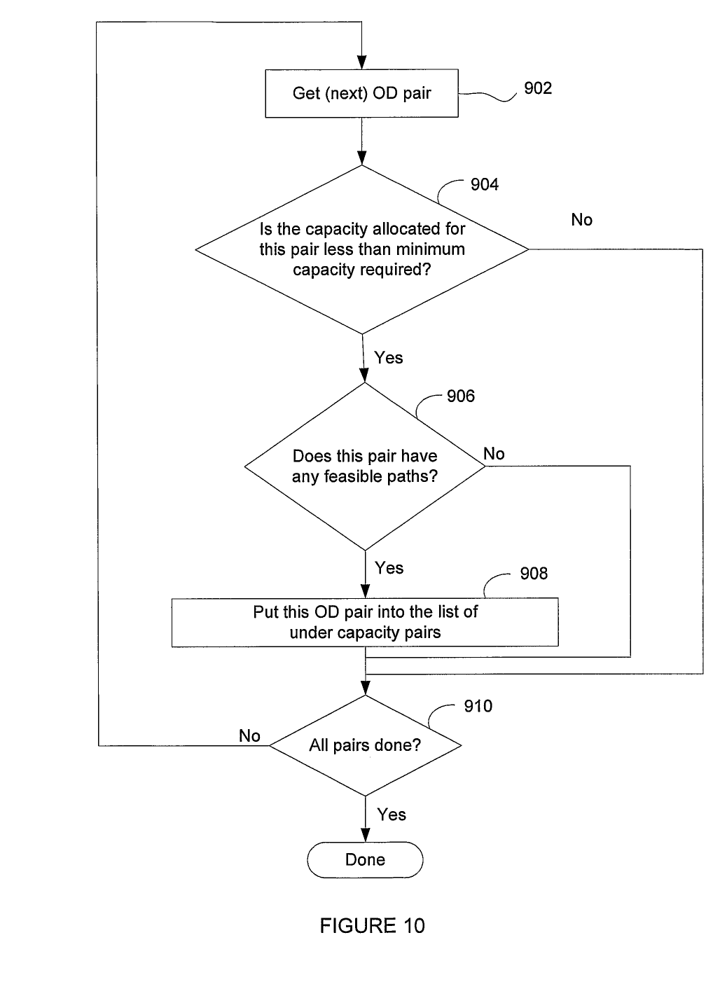

Once all the OD pairs in the solution list are processed, a list of under capacity OD pairs with feasible paths is created at step 406. At step 902, as shown in FIG. 10, the next OD pair in the solution list is accessed, and at step 904 a determination is made as to whether the capacity allocated for the OD pair is less than the minimum capacity required based on the current traffic demand vector. If so, additional capacity needs to be allocated and a determination is made at step 906 as to whether the OD pair has any feasible paths. If so, the OD pair is placed in the list of under capacity OD pairs (908) and then a determination is made at step 910 as to whether all the OD pairs have been processed.

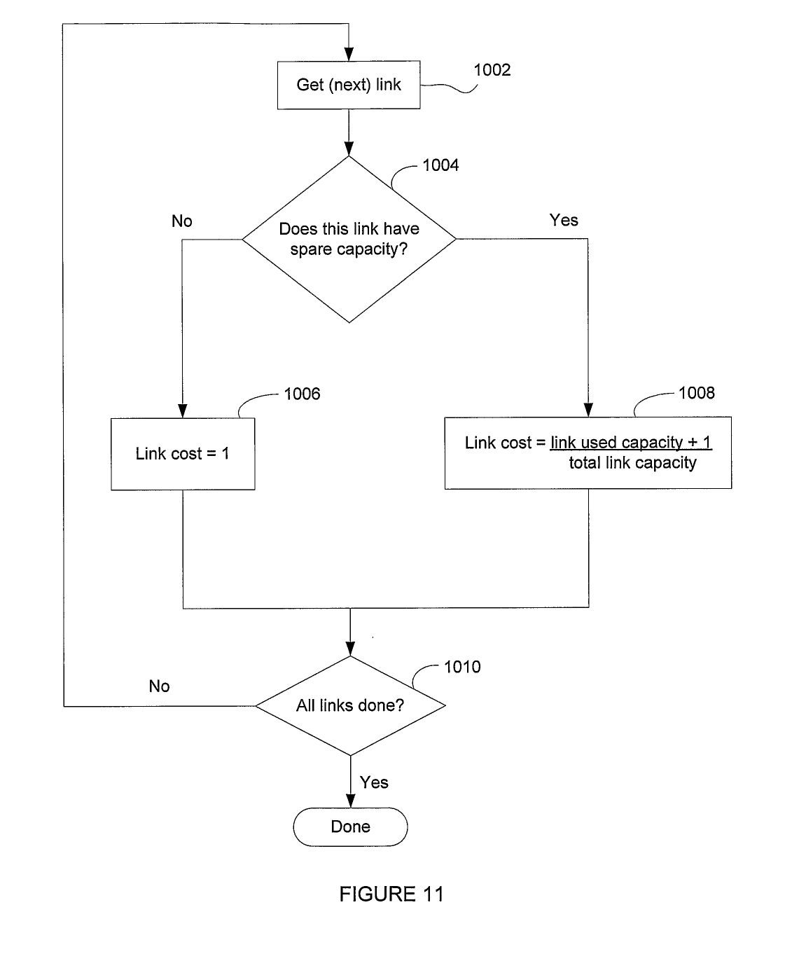

At step 408 all link costs are determined. At step 1002, as shown in FIG. 11, the next link in the solution list is accessed, and a determination made at step 1004 as to whether the link has any spare capacity. If not the link cost assigned is given a value of 1 (step 1006). Otherwise, the link cost assigned is the link used capacity x plus 1 divided by total link capacity z (1008). At step 1010 a determination is made as to whether all the links of the solution list have been processed.

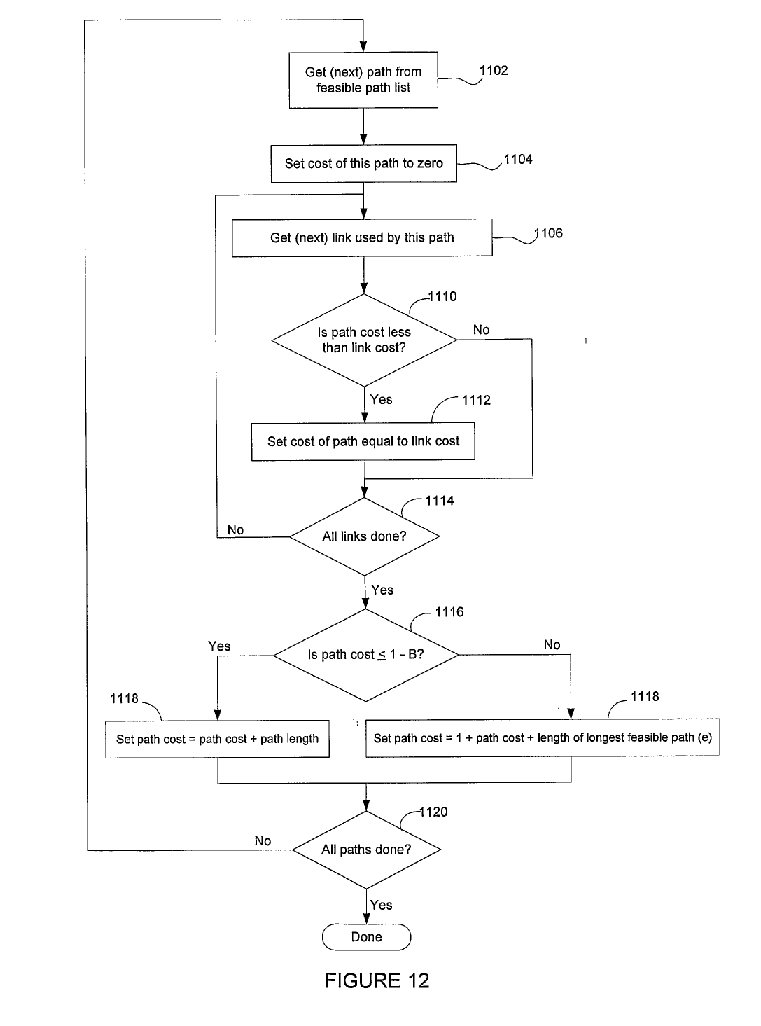

At step 410 a cost is determined for each of the paths in the feasible paths list. Path costs may involve path length, transmission time measures or other various path quality metrics, and depends on the objective function, which in this instance is M×B−U. At step 1102, as shown in FIG. 12, the data for the next path in the feasible path list is accessed and the cost of the path is set to 0 (1104). The next link used by the path is accessed at step 1106 and a determination is made, based on the cost determined for each link previously, whether the path cost is less than the link cost (1110). If it is, the cost of the path is set equal to the link cost (1112), so that the cost of any path is equal to the highest link cost of the path. A determination is made at step 1114 as to whether all links in the path have been processed, and then if they have all been processed, a determination is made (1116) as to whether the cost of the path is less than or equal to 1 minus the balance B. The value 1−B is the current maximum fractional capacity usage over all the links. The link cost determined previously represents the new fractional capacity usage of the link should an extra unit of capacity be needed from that link. At this point in the process the path cost is the maximum value of this new fractional usage over all the links traversed by the path. If a given path p is selected to carry this extra unit of capacity and the path cost of p is greater than 1−B then the act of assigning this extra unit to p will cause the network balance B to decrease. If, on the other hand, the path cost of p is less than 1−B the network balance will not be affected by this extra allocation of capacity. If the cost of the path is less than 1−B, the path cost is set to be equal to the path cost plus the path length (1118), otherwise the path cost is set to be 1 plus the path cost, plus the length of the longest feasible path (e) (1119). Paths that will not affect the value of B are preferable to paths that will affect B. The addition of the path length to the path cost reflects the increase in the value of U should this path be required to carry an extra unit of capacity. In order to preferentially select paths that do not affect B, the ones that do are penalised by as much as possible. Adding the length of the longest feasible path +1 to that path cost instead of just the path length ensures that their cost will be greater than any other path which does not affect B. If all of the paths in the feasible path list have not been processed (1120) operation returns to step 1102, otherwise this procedure completes and operation proceeds to step 412.

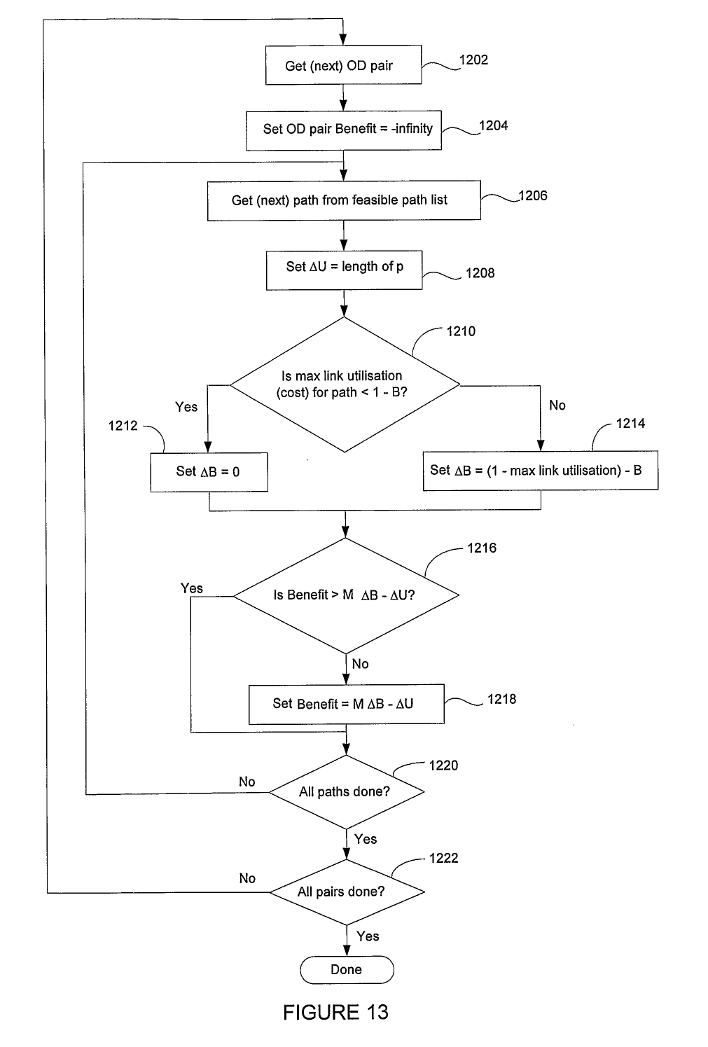

At step 412, a benefit value for each OD pair in the under capacity OD pair list is determined. Each OD pair in the list is associated with a benefit value, which represents the change in an objective function if the capacity allocation for the OD pair is increased by one unit. The objective function selected does not need to be linear and the MIH process can be adjusted to apply to different objective functions, as discussed below. At step 1202, as shown in FIG. 13, the next OD pair in the list is accessed and a benefit for the OD pair is initially set at minus infinity, i.e. as low as possible (1204). The next path in the feasible path list which belongs to this OD pair is accessed (1206) and a variable representing usage change ΔU is set to be the length of the path (1208). If a path carries one extra unit of capacity then every link in that path is needed to carry an extra unit of capacity. The number of links on the path is the same as the path length and hence an increase of 1 in the allocated capacity of a path corresponds to an increase of n units in U where n is the path length of the path. If the maximum link cost for the path is less than 1 minus B, then a variable representing benefit change ΔB is set to 0 (1212) otherwise the variable ΔB is set to be (1-max link utilisation)-B (1214). If the maximum link cost for the path is less than 1−B then B will not change if the path is selected to carry an extra unit of capacity, hence the change in B (ΔB) is 0. Otherwise the change will be the new value of B minus the current value of B. The new value of B is 1 minus the maximum link cost for the path. If a benefit value being maintained is not greater than M×ΔB−ΔU (1216), then the benefit, as discussed previously, is set to be M×ΔB−ΔU (1218). M is a positive constant which is used to adjust the relative importance of the B and U terms in the optimisation. The smallest possible change in the objective function is sought, because any allocation of capacity in general only serves to decrease B and increase U. So the benefit for an OD pair is the minimum decrease in the objective when all the paths belonging to this pair are examined in turn as candidates to carry an extra unit of capacity. The minimum decrease corresponds to the maximum value of M×ΔB−ΔU. If all of the paths in the feasible path list belonging to this OD pair have not been processed operation returns to step 1206, otherwise the operation proceeds to step 1222 and it is determined as to whether all of the OD pairs have been processed.

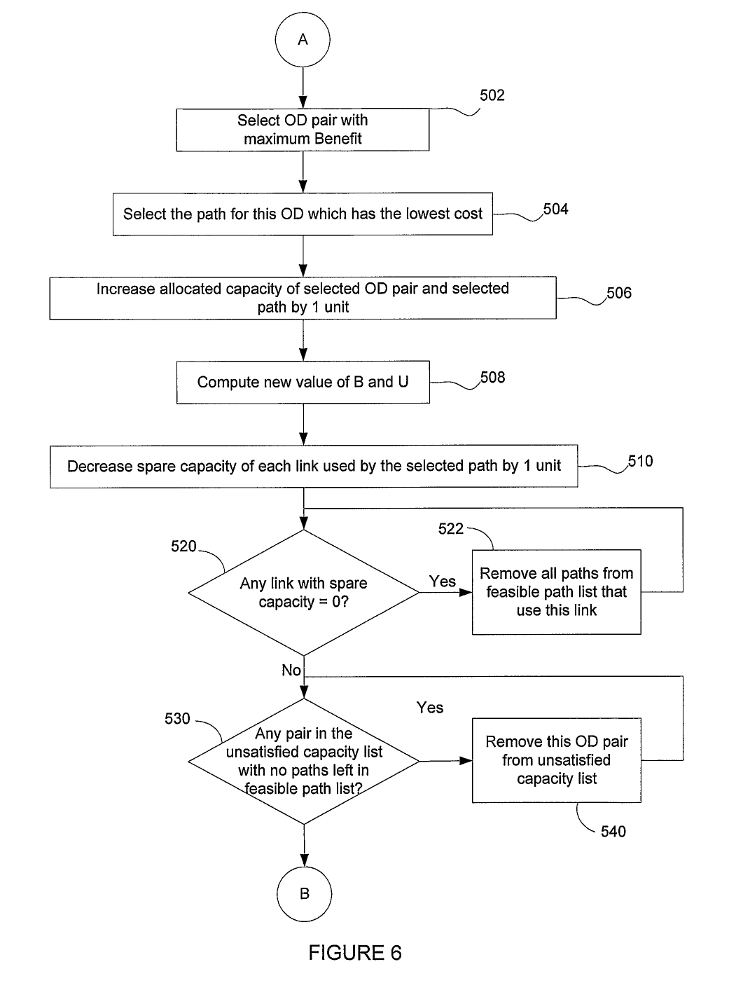

After step 412 operation proceeds to step 502, as shown in FIG. 6. If the objective function is to be maximised, then the OD pairs are processed, once the benefit value has been allocated, in decreasing order, but if it is to be minimised, then the list is sorted in an increasing order. For the process described herein, the objective function is to be maximised, and accordingly step 502 commences by accessing the OD pair with maximum benefit value. The path of the OD pair which has the lowest cost is accessed (504). The capacity of the selected OD pair and the selected path is increased by one unit of capacity at step 506, and then a new value of B and U for the network determined at step 508 (using the process described above with reference to FIG. 8). The spare capacity y of each link used by the selected path is decreased by one unit (510) and then a determination is made as to whether any link in the path now has a spare capacity of 0 (520). If so, all paths in the feasible path list that use this link are removed from the feasible path list (step 522). At step 530 a determination is made as to whether any OD pair in the unsatisfied capacity list has no path left in the feasible path list. If so, the OD pair is removed from the unsatisfied capacity list (540). In this situation the parameters for the LSP request for this OD pair cannot be met, hence the LSP manager 140 is advised and then either the associated request is rejected or modified to suit.

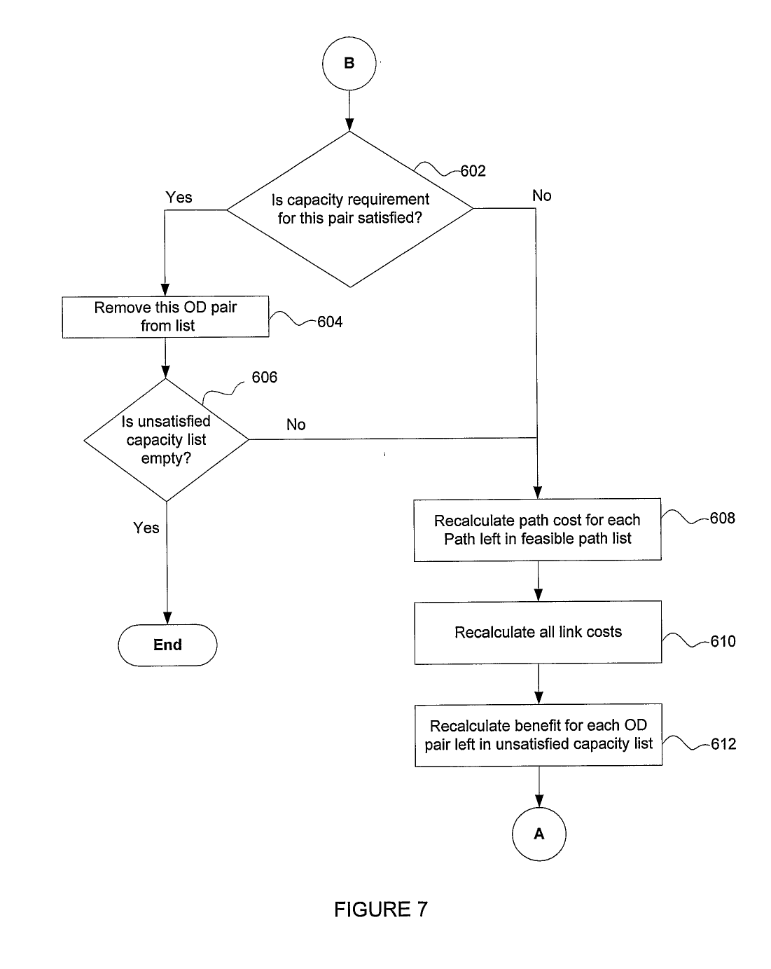

Operation then proceeds to step 602, as shown in FIG. 7, and a determination is made as to whether the capacity requirement for the selected OD pair is now satisfied. If so, the OD pair is removed from the unsatisfied capacity list (604) and if the unsatisfied capacity list is empty (606) the MIH process ends. If the capacity requirement for the OD pair is not satisfied or the unsatisfied capacity list is not empty, then the path cost is recalculated for each path left in the feasible path list (608) (using the process described above with reference to FIG. 12). The link costs are recalculated (610) (using the procedure described with reference to FIG. 11) and the benefit value is also recalculated for each OD pair left in the unsatisfied capacity list (612) (using the procedure described with reference to FIG. 13). Operation of the MIH process then returns to step 502. The path costs, link costs and benefit values are recalculated as the assigned capacity to one OD pair can affect other OD pairs. Another implementation could avoid any unnecessary recomputation of path and link costs. For example, only the cost of the links used by the path selected at step 506 can change, hence only the cost of feasible paths which share these links can change. If the value of B was not affected then the OD pair benefit can only change if some paths for the OD pair are no longer feasible and in this case only if the path formerly associated with the maximum benefit is now no longer feasible.

The network optimisation system is particularly advantageous as the neural network 200 seeds the MIH process 210 with a LSP solution that is close to that desired, and gives rise to a drastically reduced solution time, by about a factor of around 40 at periods of high traffic demand. Once trained, the neural network 200 can produce a solution in the order of milliseconds and the MIH process can be made sufficiently efficient so that the combined time is on average less than 1 second on a current personal computer. This decrease in execution time means that the real-time reconfiguration of network resources becomes feasible. The development of MPLS for IP networks also allows the explicit configuration of the network paths, and gives rise to an opportunity for effectively optimising IP traffic flows using the network optimisation system.

Many modifications will be apparent to those skilled in the art without departing from the scope of the present invention as hereinbefore described with reference to the accompanying drawings. For example, it will be appreciated by those skilled in the art that the components of the network optimisation system can be built using a variety of software and hardware combinations configured to operate as described above. Computer programs written using languages, such as Java (http://www.java.sun.com), Perl (http://www.perl.org) and C++, can be developed to implement various processes of the system and run on existing operating systems and hardware platforms, with the various databases provided using software, such as MySQL4 (http://www.mysql.org). Processes of the optimisation system can also be performed by dedicated hardware circuits, e.g. ASICs and FPGAs.

1. A network optimisation system, including:
a neural network module for receiving traffic data representing traffic for a communications network and generating path configuration data representing paths between origin and destination nodes of said network for said traffic; and
an analysis module for processing said path configuration data and said traffic data and generating optimal path configuration data for said traffic.

2. A network optimisation system as claimed in claim 1, wherein said traffic data represents capacity demands between said origin and destination nodes.

3. A network optimisation system as claimed in claim 1, wherein said path configuration data represents one or more respective paths between said origin and destination nodes, said paths including links between said nodes of said network and having an allocated capacity.

4. A network optimisation system as claimed in claim 1, wherein said analysis module processes said path configuration data using a marginal increase heuristic (MIH) process.

5. A network optimisation system as claimed in claim 1, wherein said analysis module determines feasible paths with available capacity from said path configuration data, and allocates a capacity increase to said feasible paths until capacity allocated between said origin and destination nodes meets demands defined by said traffic data.

6. A network optimisation system as claimed in claim 5, wherein said analysis module allocates cost values to said feasible paths, allocates benefit values to under capacity pairs of said origin and destination nodes, selects one of said pairs with a predetermined benefit value, and allocates capacity to a feasible path of said one of said pairs with a predetermined cost.

7. A network optimisation system as claimed in claim 6, wherein said benefit values are determined based on changes in network balance and usage measures for said network on performing capacity changes for said pairs.

8. A network optimisation system as claimed in claim 7, wherein said predetermined benefit value is a maximum benefit value for said pairs and said predetermined cost is a lowest cost for said one of said pairs.

9. A network optimisation system as claimed in claim 1, wherein said neural network module is trained using optimal path configuration data generated by a mixed integer linear programming (MILP) process.

10. A network optimisation system as claimed in claim 1, including a training data generator including a mixed integer linear programming (MILP) solver for processing training traffic data and network topology data to generate path configuration data for use as training data for said neural network module.

11. A network optimisation system as claimed in claim 10, wherein said training data generator includes a random traffic generator for generating random traffic data as said training traffic data.

12. A network optimisation system as claimed in claim 10, wherein said training traffic data is obtained from measurement data collected for traffic of said network.

13. A network optimisation system as claimed in claim 10, including a neural network trainer for training a neural network of said neural network module on the basis of said training data.

14. A network optimisation system as claimed in claim 1, including a path configuration system for generating control messages to configure nodes of said network based on said optimal path configuration data.

15. A network optimisation system as claimed in claim 1, wherein said traffic data represents current traffic demand for said network and any traffic request for a path.

16. A network optimisation system as claimed in claim 1, wherein said network is a multi-protocol label switching (MPLS) network and said paths are label switch paths (LSPs).

17. A network optimisation process, including:
receiving traffic data representing traffic for a communications network;
processing said traffic data using a neural network to generate path configuration data representing paths between origin and destination nodes of said network for said traffic; and
processing said path configuration data and said traffic data to generate optimal path configuration data for said traffic.

18. A network optimisation process as claimed in claim 17, wherein said traffic data represents capacity demands between said origin and destination nodes.

19. A network optimisation process as claimed in claim 17, wherein said path configuration data represents one or more respective paths between said origin and destination nodes, said paths including links between said nodes of said network and having an allocated capacity.

20. A network optimisation process as claimed in claim 17, wherein said processing said path configuration data includes using a marginal increase heuristic (MIH) process.

21. A network optimisation process as claimed in claim 17, wherein said processing said path configuration data includes determining feasible paths with available capacity from said path configuration data, and allocating a capacity increase to said feasible paths until capacity allocated between said origin and destination nodes meets demands defined by said traffic data.

22. A network optimisation process as claimed in claim 21, including allocating cost values to said feasible paths, allocating benefit values to under capacity pairs of said origin and destination nodes, selecting one of said pairs with a predetermined benefit value, and allocating capacity to a feasible path of said one of said pairs with a predetermined cost.

23. A network optimisation process as claimed in claim 22, wherein said benefit values are determined based on changes in network balance and usage measures for said network on performing capacity changes for said pairs.

24. A network optimisation process as claimed in claim 23, wherein said predetermined benefit value is a maximum benefit value for said pairs and said predetermined cost is a lowest cost for said one of said pairs.

25. A network optimisation process as claimed in claim 17, wherein said neural network is trained using optimal path configuration data generated by a mixed integer linear programming (MILP) process.

26. A network optimisation process as claimed in claim 17, including processing training traffic data and network topology data using a mixed integer linear programming (MILP) process to generate path configuration data for use as training data for said neural network.

27. A network optimisation process as claimed in claim 26, including generating random traffic data as said training traffic data.

28. A network optimisation process as claimed in claim 26, wherein said training traffic data is obtained from measurement data collected for traffic of said network.

29. A network optimisation process as claimed in claim 17, including generating control messages to configure nodes of said network based on said optimal path configuration data.

30. A network optimisation process as claimed in claim 17, wherein said traffic data represents current traffic demand for said network and any traffic request for a path.

31. A network optimisation process as claimed in claim 17, wherein said network is a multi-protocol label switching (MPLS) network and said paths are label switch paths (LSPs).
